(19) United States
(12) Patent Application Publication
(10) Pub. No.: US 2005/0076755 A1
(43) Pub. Date: Apr. 14, 2005

(54) Method and apparatus for machining fiber cement

(76) Inventors: Michael H. Zimmerman, Naperville, IL (US); Dwight E. Dyer, Kingston, OH (US)

Correspondence Address: Pepper Hamilton LLP;Firm 21269, 500 Grant Street, 50th Floor, One Mellon Center, Pittsburgh, PA, 15219, US

(21) Appl. No.: 10/799,556

(22) Filed: Mar. 11, 2004

Related U.S. Application Data
(60) Provisional application No. 60/453,487, filed on Mar. 11, 2003.

(51) Int. Cl. B23B 3/00

(52) U.S. Cl. 82/1.11; 407/113

(57) ABSTRACT

A method for machining a fiber cement workpiece into desired dimensions and geometry is disclosed. The method comprises the steps of employing a machine tool to make contact with said fiber cement workpiece and removing material by generating continuous and or semi-continuous chips out of said fiber cement workpiece. The improvement comprises employing a machining tool having at least a cutting tool insert mounted onto said machining tool, said tool insert comprising a superabrasive material of polycrystalline diamond (PCD) or polycrystalline boron nitride (PCBN) having an average grain size less than or equal to about 10 μm.

This application claims priority to U.S. provisional application Ser. No. 60/453,487,filed Mar. 11, 2003 and entitled “Apparatus to Machine Fiber Cement Parts and Methods to Manufacture Apparatus Thereof”, herein incorporated by reference in its entirety.

### FIELD OF THE INVENTION

The present invention relates to a method and apparatus for cutting a fiber-cement material.

### BACKGROUND OF THE INVENTION

Fiber-cement (FC) parts such as pipes, siding, and the like offer several advantages compared to competitive materials. FC is made from a mixture of cement, silica sand, cellulose and a binder. To form a FC product, a liquid fiber-cement mixture is pressed and then cured to form into siding, shingles, pipes, panels, boards, and the like. FC is advantageous because it is non-flammable, weatherproof, and relatively inexpensive to manufacture. Additionally, FC parts do not rot or become infested by insects, thus they are quite durable.

FC components are advantageous due to their durability. However, the sand in the FC makes the material highly abrasive and difficult to saw or machine, which demands an abrasion-resistant tool. Sawing is typically used to reduce in size the FC components such as sheet, stock, bar, rod, and pipe for subsequent machining. In sawing, the workpiece material being cut is kept stationary, while the cutting tool (i.e., the saw) is rotating and moving through the workpiece, and the cutting elements are in intermittent contact with said workpiece, creating broken or fine chips or “dust” for a very unpleasant working environment. For example, International Patent Application No. WO0043179, entitled “Saw Blade For Cutting Fiber Cement”, filed Jan. 24, 2000, discloses a saw blade for cutting FC components with polycrystalline diamond tips and a specific design to minimize generated dust and chips.

After sawing, further processes are necessary for some FC components to achieve a final geometry and/or dimensional tolerances. In “turning” operations, the workpiece (either in original form or after being sawed or cut into a round shape) is rotated about its axis on a lathe. Milling is similar in concept to turning with the tool making continuous contacts with the workpiece creating a semi-continuous chips comprising the cellulose fibers, cement, etc. However, there are two major differences between milling and turning. In milling, a multi-tooth cutter is used. Additionally, the cutter rotates along various axes with respect to the workpiece to produce variety of configurations on the workpiece.

Edge dulling of the tool during the formation of the continuous or semi-continuous chips can sometimes damage the FC machined surfaces. The cellulose fibers contained in the parts are very fragile, and they can be easily torn during machining or milling. When this happens, the tool's useful life is prematurely terminated, even if the tool has not worn out completely.

It has been suggested in the prior art that wear performance of machining tools is dependent on the grain size of the tool's diamond layer, with the average grain size of 25 to 40 μm polycrystalline diamond (“PCD”) offering the best combination of abrasion resistance and surface finish of machined workpieces. For example, GE COMPAX Tool Blanks Technote dated Aug. 24, 1992, entitled “Machining Metal matrix Composites (Aluminum with 20% SiC) with Compax* Diamond Tool Blanks”, describes the benefits of increasing grain size on tool wear performance. This reference describes that the rate at which a tool wears decreases with increasing grain size in the range of about 2-75 μm. Tool materials comprising the finer average grain size PCD were shown to have lower tool efficiencies than those having an average grain size of 25 μm or above. The aluminum-SiC composite of the Technote is a “highly abrasive” work piece material. Similarly, fiber cement is highly abrasive, owing to the high silica content.

Accordingly, it is desirable to increase tool efficiencies for machining tools comprising PCD or polycrystalline boron nitride (“PCBN”) having an average grain size of less than about 25 μm.

### SUMMARY OF THE INVENTION

Surprisingly and advantageously, the Applicants have found that in machining fiber cement components, tool materials comprising finer average grain size PCD and/or PCBN of 10 μm or below provide the best combination of improved surface appearance and tool efficiencies. The use of tools with grain size of10 μm or below extends the useful tool life by providing sufficient abrasion resistance while avoiding the unwanted affect of tearing the cellulose fibers in the fiber cement workpiece during the machining or cutting.

One embodiment of the invention relates to a method for machining a fiber cement workpiece into desired dimensions and geometry, comprising the steps of employing a machine tool to make continuous contact with said fiber cement workpiece and removing material of the workpiece by generating continuous and/or semi-continuous chips out of said fiber cement workpiece. Another embodiment of the present invention is a method employing a machining tool having a cutting tool insert mounted onto said machining tool, said tool insert comprising a superabrasive material PCD or PCBN having an average grain size less than or equal to 10 μm. Another embodiment of the present invention is a cutting tool insert for use in connection with a machining tool comprising a superabrasive PCD or PCBN having an average grain size less than or equal to 10 μm. Another embodiment of the present invention is a fiber cement workpiece of desired dimensions and geometry, wherein said workpiece is machined into a desired dimension and geometry and wherein said workpiece exhibits no tearing on its surface after such machining.

### BRIEF DESCRIPTION OF THE DRAWINGS

FIGS. 1A and 1B illustrate a turning tool and a milling tool, respectively.

FIG. 2 is a plot comparing the tool wear rate of the machine tools of an embodiment of the present invention and the prior art, in similar machining operating conditions.

FIGS. 3A and 3B are photographs showing a fiber cement workpiece with torn cellulose fibers after 20 passes using a machining tool of the prior art, as compared to a fiber cement workpiece which exhibits no tearing on the surface after 25 passes using a machining tool of an embodiment of the present invention.

FIGS. 4A-6B compare the cutting inserts employing a PCD blank of an embodiment of the present invention with the PCD blanks of the prior art, after a machining operation.

### DETAILED DESCRIPTION OF THE INVENTION

Before the present compositions and methods are described, it is to be understood that this invention is not limited to the particular processes, compositions, or methodologies described, as these may vary. It is also to be understood that the terminology used in the description is for the purpose of describing the particular versions or embodiments only, and is not intended to limit the scope of the present invention which will be limited only by the appended claims.

It must also be noted that as used herein and in the appended claims, the singular forms “a”, “an”, and “the” include plural reference unless the context clearly dictates otherwise. Thus, for example, reference to a “tool” is a reference to one or more tools and equivalents thereof known to those skilled in the art, and so forth. Unless defined otherwise, all technical and scientific terms used herein have the same meanings as commonly understood by one of ordinary skill in the art. Although any methods and materials similar or equivalent to those described herein can be used in the practice or testing of embodiments of the present invention, the preferred methods, devices, and materials are now described. All publications mentioned herein are incorporated by reference. Nothing herein is to be construed as an admission that the invention is not entitled to antedate such disclosure by virtue of prior invention.

The present invention relates to cutting tools for turning or milling operations. One embodiment of the invention is a method of cutting a fiber cement workpiece with a machine tool. Another embodiment of the present invention is a machine insert comprised of a superabrasive material with finer average grain size PCD and/or PCBN of about 10 μm or below. As previously indicated, in turning, the workpiece is rotated and the cutting tool is stationary; in milling, the cutting tool rotates and the workpiece moves in transition only. The various methods of the present invention are useful in both turning and milling applications. Another method of the present invention is a fiber cement workpiece which has been machined with a machine tool which exhibits no tearing on its surface after such cutting.

Machining Tool Embodiments of the Present Invention. As used herein, “machining” tools are used interchangeably with “cutting” tools to refer to tools for use in turning or milling operations, for making continuous contact and moving with the fiber cement workpiece creating continuous or semi-continuous chips in the process of machining the workpiece into desired dimensions and or geometry, e.g., circular convex and concave surfaces, non-circular shapes, non-standard angles and odd cross-sections, etc.

The chip formation process is well known in the machining art. A tool contacts the workpiece and forces material to separate from the workpiece, known as a chip. Chip formation may be continuous, discontinuous, or semi-continuous, all terms that are known in the art depending on the tool contact, speeds and materials involved in the machining process.

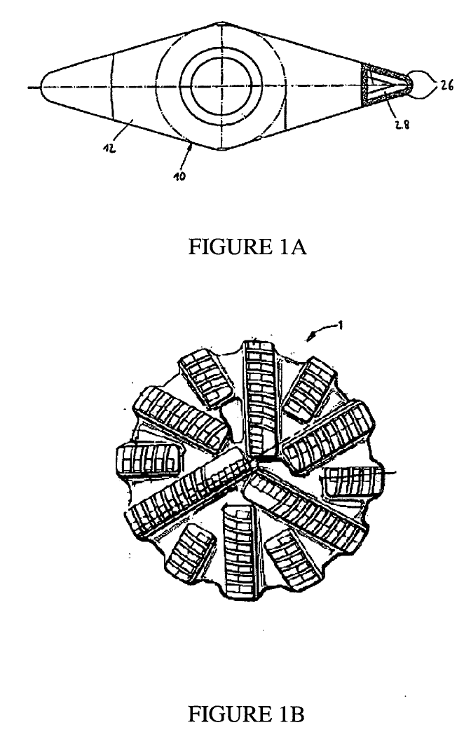

In one embodiment of the invention, a FC workpiece is mounted on a lathe headstock spindle in a machine (turning) tool rotated about the headstock spindle axis. The turning tool is mounted on a tool holder carriage adapted to move in translation along the FC workpiece. As shown in FIG. 1 of one embodiment, the turning tool has a cutting edge to be individually engaged with the FC workpiece. In another embodiment (not illustrated), the turning tool has a cutting edge made up of a plurality of cutting edge portions adapted to be individually engaged with the FC workpiece resulting in parallel or helical threads on the surface of the workpiece.

In another embodiment of the invention in the form of a “milling” tool as illustrated in FIG. 1B, with a cutter having a plurality of cutting elements. In the figure, the milling tool has a tubular body member and a crown portion having a plurality of circumferentially spaced and radially extending ribs with cutting elements in the ribs.

Cutting Elements/Inserts Embodiments of the Present Invention. In one embodiment of the present invention, the improved cutting tool has a shaped body formed from a sintered carbide steel or the like, having a cutting element or cutting insert (28 in FIG. 1A) attached to the tip or the end of the tool. In another embodiment, the cutting elements or inserts are attached to the ribs of the tool as in the milling tool of FIG. 1B.

The insert substantially comprises superabrasive materials of PCD, PCBN, or mixtures thereof, commercially available from various sources, including Diamond Innovations, Inc., as “superabrasive tool blanks.” The average grain size of the superabrasive materials in the present invention is of about 10 μm or less for sufficient abrasion resistance while minimizing the unwanted effect of tearing the cellulose fiber in the machining of FC components.

Both PCD and PCBN are suitable materials for the tool blanks of the present invention. As known in the art, superabrasive is the term used to describe Diamond and CBN (cubic boron nitride) due to their high hardness. Superabrasives make up a special category of bonded abrasives designed for machining the hardest, most challenging work materials.

Suitable inserts or superabrasive tool blanks are generally thermally stable compacts of PCD or PCBN bonded to supports of cemented metal carbide or similar materials known as a substrate. The interface between the diamond or PCBN compact and substrate support may be planar, or may be irregular to promote adhesion between the layers.

A compact may be characterized generally as an integrally bonded structure formed of a sintered, polycrystalline mass of abrasive particles, such as diamond or cubic boron nitride. The compact may be self-bonded, or may include a suitable bonding matrix of about 5% to 35% by volume. The bonding matrix usually is a metal such as cobalt, iron, nickel, platinum, titanium, chromium, tantalum, copper, or an alloy or mixture thereof. The matrix additionally may contain recrystallization or growth catalyst such as aluminum for CBN or cobalt for diamond. The support cemented metal carbide comprises tungsten, titanium, or tantalum carbide particles, or a mixture thereof, which are bonded together with a binder of between about 6% to about 25% by weight of a metal such as cobalt, nickel, or iron, or a mixture or alloy thereof.

The process to form the superabrasive tool blanks is done via a high pressure/high temperature (HP/HT) method. The process involves placing an unsintered mass of abrasive, crystalline particles, such as diamond or CBN, or a mixture thereof, within a protectively shielded enclosure disposed within the reaction cell of an HP/HT apparatus. Additionally placed in the enclosure with the abrasive particles may be a metal catalyst if the sintering of diamond particles is contemplated, as well as a pre-formed mass of a cemented metal carbide for supporting the abrasive particles and thus forming the support for the compact. The contents of the cell then are subjected to processing conditions sufficient to effect intercrystalline bonding between adjacent grains of abrasive particles and, optionally, the joining of sintered particles to the cemented metal carbide support. Such HP/HT processing conditions generally involve the imposition for about 3 to 120 minutes of a temperature of at least 1000° C. and a pressure of at least 20 Kbar.

Superabrasive blanks having an average grain size of 10 μm or less are commercially available from Diamond Innovations, Inc., in the form of cylindrical body or disc of a polycrystalline diamond or cubic boron nitride layer bonded to a metal carbide substrate layer having a thickness of about 0.3 to 2 mm, and about 10 mm to 74 mm in diameter.

Forming Desired Machining Tool blank shape Embodiments of the present invention. As used herein, “tool insert” or simply “tool” is used to refer to the tool body, tool block, of the machining tool embodiments of the present invention into which the superabrasive blank of an average particle size of about less than 10 μm is to be brazed. The PCD or PCBN insert shape may be made from a blank via processes known to the art including Electro Discharge Machining (EDM), Electro Discharge Grinding (EDG), laser, plasma, and water jet. In one embodiment, the surface of the blank is laser-etched at selected positions on the surface or according to a predetermined computer controlled pattern for a final desired shape for optimum machining of fiber cement parts. In another embodiment, appropriate relieved tooth formed out of the PCD blank of the invention is mounted onto the machining tool as to eliminate any further grinding step. Another embodiment of the invention is to form a relatively large diameter blank of PCD/carbide, and then to form into an array of relieved tips in the milling tool, such as by EDM cutting. Each tool insert may optionally contain a pocket for receiving the superabrasive blank.

The brazing may be done under controlled atmosphere conditions. The brazing can be done by any brazing means in the art including dip brazing, furnace brazing, brazing by torch heating, brazing by induction heating, and brazing by resistance heating. Brazing temperature depends in part on the type of braze alloy used, and are typically in the range of about 525° C. to about 1650° C.

### EXAMPLE

The examples below and as generally illustrated by FIGS. 1-6 are merely representative of the work that contributes to the teaching of the present invention, and the present invention is not to be restricted by the examples that follow.

### Example 1

To demonstrate the effects of grain size on the life of a PCD cutting tool used to machine fiber cements, turning tests were conducted on fiber cement drain pipes fabricated to ASTM standard C1450/C1450M-02. Pipes were turned on a Harrison V530 lathe operating at a feed rate of 0.0275 in/min, a depth of cut of 0.040 in, and a speed of 450 surface feet/min. These conditions yield a material removal rate of about 6 in³/min, similar to that used for machining the pipes' joints. Tests were conducted with PCD tools whose average grain sizes were: 20 μm, 8 μm, and 5 μm.

The turning operation was repeated up to a total of 25 passes, where one pass is equivalent to a material removal of approximately 29 in³ of workpiece material. At five pass intervals, the tests were paused to evaluate tool wear and work piece surface quality.

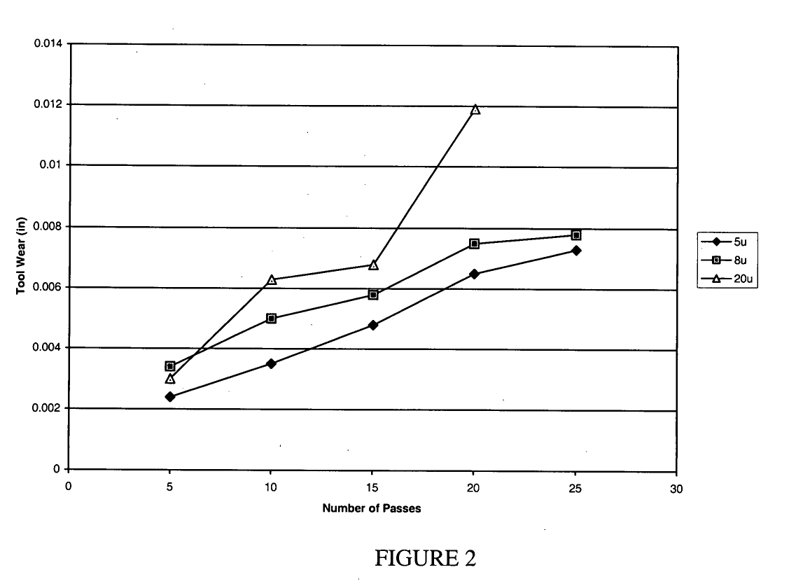

FIG. 2 shows wear as a function of number of passes for the different PCD tools. PCD tools with an average grain sizes of about 8 μm and about 5 μm displayed suitable tool wear according to one embodiment of the present invention. The 8 μm and 5 μm tools exhibited a tool wear of less than 0.008 inch over 25 passes, exhibiting good tool wear, whereas the 20 μm tool exhibited wear of about 0.012 inch after 20 passes.

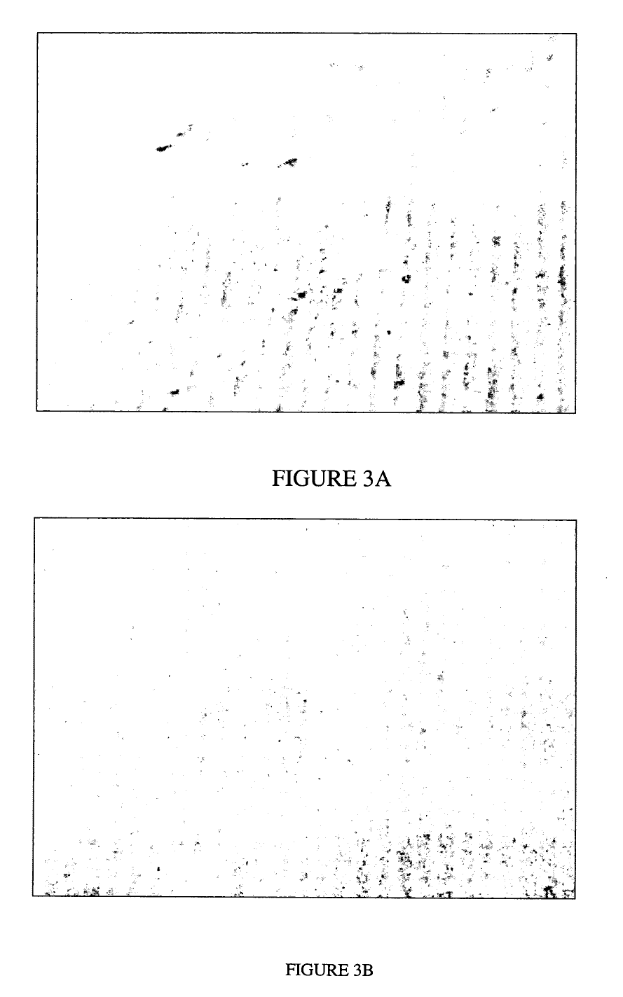

During the course of the tests, integrity of the fiber cement surface was also evaluated by visual inspection. Fiber cement workpieces cut with PCD tools with average grain sizes of about 8 μm and about 5 μm exhibit no tearing on the surface. FIGS. 3A and 3B are photographs showing a fiber cement workpiece with torn cellulose fibers after 20 passes using a machining tool of 20 μm, as compared to a fiber cement workpiece which exhibits no tearing on the surface after 25 passes using a machining tool of 8 μm. FIGS. 3A and 3B compare the “good” surface as obtained with the machining tool of the present invention with the “bad ” or “poor” surfaces obtained with the machining tool of 20 μm. FIG. 3A is a FC workpiece that has been machined with a tool with an average grain size of 20 μm. By contrast, the FC workpiece in FIG. 3B was machined with a tool with an average grain size of 8 μm.

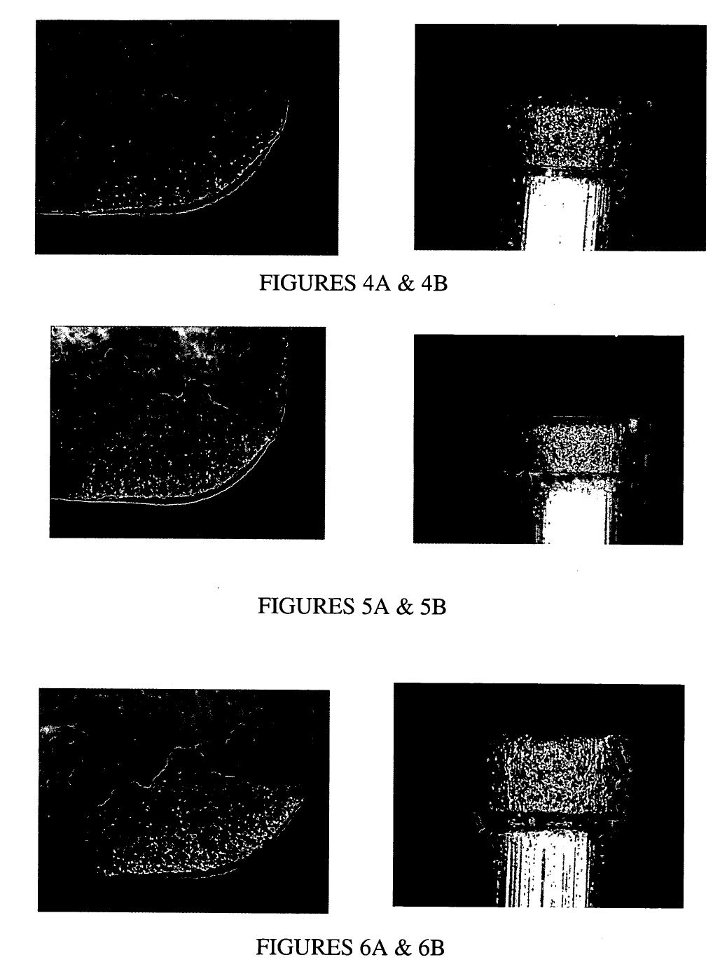

FIGS. 4A-4B, 5A-5B, and 6A-6B are photographs of the worn cutting tool edges employing diamond compacts from General Electric Company of 90-92 vol. % diamond with an average particle size of 8 μm, 5 μm, and 20 μm respectively. As seen in FIGS. 4A-6B, the edges of tool inserts with an average particle size of 8 μm and 5 μm exhibit a smooth wear profile after machining the fiber cement. See FIGS. 4A-4B, 5A-5B which display 8 μm and 5 μm tools respectively. The 20 μm tool exhibits a jagged wear profile after machining the fiber cement. See FIGS. 6A-6B.

Although the present invention has been described in considerable detail with reference to certain preferred embodiments thereof, other versions are possible. Therefore the spirit and scope of the appended claims should not be limited to the description and the preferred embodiments disclosed herein.

1. A method for machining a fiber cement workpiece comprising:
operating a machining tool to machine a fiber cement workpiece to generate chips out of the workpiece, wherein the machining tool comprises a cutting tool insert comprising a superabrasive material having an average grain size of less than or equal to about 10 μm.

2. The method of claim 1, wherein the superabrasive material is PCD or PCBN.

3. The method of claim 1, wherein the cutting tool insert is formed by HP/HT.

4. The method of claim 1, wherein the chips are continuous or semi-continuous.

5. The method of claim 1, wherein the fiber cement workpiece is rotated about an axis in order to make continuous contact with the machining tool.

6. The method of claim 1, wherein the machining tool rotates around the fiber cement workpiece during machining.

7. A cutting tool insert for use in connection with a fiber cement machining tool comprising a superabrasive blank having an average grain size less than or equal to about 10 μm.

8. The cutting tool insert of claim 7, wherein the superabrasive blank comprises PCD or PCBN.

9. The cutting tool insert of claim 7, wherein the superabrasive blank is formed with HP/HT.

10. The cutting tool insert of claim 7, further comprising a substrate, wherein the superabrasive is bonded to the substrate.

11. A cutting tool insert of claim 7, wherein the surface of the superabrasive blank is laser-etched at selected positions.

12. A cutting tool insert of claim 7, wherein the superabrasive blank is brazed into the cutting tool insert.

13. A cutting tool insert of claim 7, wherein the tool insert contains a pocket for receiving the superabrasive blank.

14. A machining tool for cutting fiber cement parts comprising a cutting tool insert, wherein the insert comprises a superabrasive blank having an average grain size less than or equal to about 10 μm.

15. The machining tool of claim 14, wherein the superabrasive blank comprises PCD or PCBN.

16. The machining tool of claim 14, where the superabrasive blank is processed by HP/HT.

17. The machining tool of claim 14, where the superabrasive blank includes a bonding matrix of about 5% to 35% by volume of the blank.

18. The machining tool of claim 14, wherein the tool is a turning tool.

19. The machining tool of claim 14, wherein the tool is a milling tool.

20. The machining tool of claim 14, wherein a relieved tooth formed out of the blank is mounted onto the machining tool.

21. The machining tool of claim 20, further including an array of relieved tips.

22. A fiber cement workpiece of desired dimensions and geometry, wherein the workpiece is machined into a desired dimension and geometry and wherein the workpiece exhibits no tearing on its surface after such machining, wherein the machining comprises:
operating a machining tool to machine a fiber cement workpiece to generate chips out of the workpiece, wherein the machining tool comprises a cutting tool insert comprising a superabrasive material having an average grain size of less than or equal to about 10 μm.

23. The fiber cement workpiece of claim 22, wherein the superabrasive material is PCD or PCBN.
